(19) United States
(12) Patent Application Publication
(10) Pub. No.: US 2025/0317377 A1
(43) Pub. Date: Oct. 9, 2025

(54) RECOGNITION OF END-TO-END NETWORK PROBE SYSTEM SYNTHETIC TRAFFIC IN AN SD-WAN NETWORK FOR SD-WAN NETWORK PATH ENRICHMENT

(71) Applicant: Cisco Technology, Inc., San Jose, CA (US)

(72) Inventors: Jianda Liu, Shanghai (CN); Zhiyong Xiao, Shanghai (CN); Laiqun Li, Zhejiang (CN); Alan Xiao-rong Wang, Shanghai (CN)

(21) Appl. No.: 18/774,304

(22) Filed: Jul. 16, 2024

Related U.S. Application Data
(60) Provisional application No. 63/631,124, filed on Apr. 8, 2024.

(51) Int. Cl. H04L 43/12; H04L 43/0876; H04L 43/50

(52) U.S. Cl. CPC H04L 43/12; H04L 43/0876; H04L 43/50

(57) ABSTRACT

A device may query, by a path insight tool, an end-to-end network probe system to obtain test information about a traffic flow originating from an endpoint outside the SD-WAN by the end-to-end network probe system, the test information including one or more flow identifiers. A device may identify from the querying one or more SD-WAN overlay devices that carried the traffic flow having one or more flow identifiers, wherein one or more SD-WAN overlay devices are translated into an SD-WAN underlay path. A device may identify a flow identifier that identifies the traffic flow in the end-to-end network probe system, associating the test information about the traffic flow from the end-to-end network probe system with the statistics associated with the traffic flow obtained as the traffic flow traversed the SD-WAN underlay path. A device may generate an end-to-end visualization from the test information from the end-to-end network probe.

### CROSS-REFERENCE TO RELATED APPLICATIONS

This application claims priority to U.S. provisional application No. 63/631,124, filed on Apr. 8, 2024, which is expressly incorporated by reference herein in its entirety.

### FIELD OF THE TECHNOLOGY

The present technology relates to the field of network communication and routing technologies and encompasses methods for associating data traffic originating from SD-WAN routers for end-to-end path visualization.

### BACKGROUND

SD-WAN represents an approach to networking that leverages software-defined networking (SDN) principles to enhance the management and operation of wide area networks (WAN). A key aspect of SD-WAN is its ability to analyze routes of paths within the network, helping network operators monitor and troubleshoot effectively. By decoupling networking hardware from its control mechanism, SD-WAN enables centralized control and orchestration of network traffic flows across geographically dispersed locations.

This centralized management gives network operators an end-to-end overview of the entire SD-WAN network and application data traffic as it travels. SD-WAN dynamically directs network traffic across various pathways, including Multiprotocol Label Switching (MPLS), broadband Internet, and cellular connections, based on real-time conditions and application requirements. This real-time analysis and policy-based routing allow SD-WAN controllers to route traffic intelligently, ensuring optimal performance and reliability. Comprehensive visibility into network paths traversed by network application data traffic facilitates proactive monitoring and efficient troubleshooting, benefiting network operators by enhancing performance, reliability, and security across the organization's branch offices, data centers, and cloud resources.

### BRIEF DESCRIPTION OF THE SEVERAL VIEWS OF THE DRAWINGS

In order to describe the manner in which the features of the disclosure can be obtained, a more description of the principles of the present technology will be rendered by reference to aspects thereof which are illustrated in the appended drawings. Understanding that these drawings depict exemplary aspects of the disclosure and are not therefore to be considered to be limiting of its scope, the principles herein are described and explained with additional specificity and detail through the use of the accompanying drawings in which:

FIG. 1 illustrates an example test setup for collecting SD-WAN traffic information by one or more end-to-end network probe system agents according to some aspects of the present technology.

FIG. 2 illustrates an example user interface for a path insight tool to receive filter configurations to filter monitored traffic flows in a network according to some aspects of the present technology.

FIG. 3 illustrates a collection of traffic flow information 300 gathered by one or more agents of the end-to-end network probe system and presented in the path insight tool according to some aspects of the present technology.

FIG. 4 illustrates an example flow readout from a query of the end-to-end network probe system by a path insight tool according to some aspects of the present technology.

FIG. 5 illustrates an example user interface of the path insight tool depicting test information for a specified traffic flow for tests deployed by the end-to-end network probe system according to some aspects of the present technology.

FIG. 6 illustrates an example view from a database storing SD-WAN edge device information according to some aspects of the present disclosure.

FIG. 7A illustrates extracted information from the database of SD-WAN edge device for mapping of the traffic flows according to some aspects of the disclosure.

FIG. 7B illustrates a mapping SD-WAN edge device and trace route path information extracted from the database according to some aspects of the disclosure.

FIG. 8A illustrates a client application visualization in the path insight tool in accordance with the mapping of the SD-WAN edge device and traceroute path information extracted from the database according to some aspects of the disclosure.

FIG. 8B illustrates a client application visualization of a mapping of the SD-WAN edge devices in accordance with the mapping of the SD-WAN edge device and traceroute path information extracted from the database according to some aspects of the disclosure.

FIG. 9 illustrates an example process for identifying an end-to-end data path and associated statistics for traffic flows that traverse a software-defined wide area network (SD-WAN) and that originate or terminate outside the SD-WAN according to some aspects of the disclosure.

FIG. 10 illustrates an example of a computing system according to some aspects of the present technology.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative and is not intended to further limit the scope and meaning of the disclosure or of any example term. Likewise, the disclosure is not limited to various embodiments given in this specification.

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

The proposed technology identifies network application test flows by retrieving keys from one or more agents through the network application API. These keys enable accurate mapping of the flows to the corresponding SD-WAN tunnel used for the test. Subsequently, the technology integrates the underlay hops associated with that SD-WAN tunnel into the network application's end-to-end path visualization. This integration enhances the granularity and comprehensiveness of the path visualization, offering a complete view that encompasses both the SD-WAN overlay and underlay network components. This detailed mapping and visualization capability facilitates more effective monitoring, troubleshooting, and optimization of network performance, providing a thorough understanding of how the network impacts application traffic.

In one aspect, the techniques described herein relate to a method for identifying an end-to-end data path and associated statistics for traffic flows that traverse a software-defined wide area network (SD-WAN) and that originate or terminate outside the SD-WAN, the method including: querying, by a path insight tool, an end-to-end network probe system to obtain test information about a traffic flow originating from an endpoint outside the SD-WAN by the end-to-end network probe system, the test information including one or more flow identifiers; identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path; identify a flow identifier that identifies the traffic flow in the end-to-end network probe system; in response to identifying the flow identifier, associating the test information about the traffic flow from the end-to-end network probe system with the statistics associated with the traffic flow obtained as the traffic flow traversed the SD-WAN underlay path; and generating an end-to-end visualization from the test information from the end-to-end network probe system and the statistics associated with the traffic flow as it traversed the SD-WAN underlay path.

In some aspects, the techniques described herein relate to a method, further including determining that the test information includes a target uniform resource locator (URL); and generating an end-to-end network probe system flow key from the one or more flow identifiers including a source agent IP address and a test target FQDN.

In some aspects, the techniques described herein relate to a method, further including determining that the test information does not include a target uniform resource locator (URL); and generating an end-to-end network probe system flow key from the one or more flow identifiers including one or more of a source agent IP address, a test target agent IP address, a destination FQDN or a test target port.

In some aspects, the techniques described herein relate to a method, wherein the end-to-end network probe system includes of one or more agents on one or more SD-WAN edge devices, wherein the path insight tool is configured to monitor the traffic flow from the one or more agents.

In some aspects, the techniques described herein relate to a method, wherein the path insight tool is configured to: monitor the traffic flows having the flow identifier by the path insight tool; or collect one or more sample data packets from the traffic flow when concurrent traffic flows exceeds a predetermined scale limit.

In some aspects, the techniques described herein relate to a method, further including constructing the test information received from the end-to-end network probe system in a mapping table including the one or more flow identifiers of tests associated with the test information.

In some aspects, the techniques described herein relate to a method, wherein generating the end-to-end visualization includes: identifying one or more internet protocol addresses associated with a test flow of an SD-WAN session between a source edge device and a destination edge device, the one or more internet protocol addresses including one or more hop addresses along a network path of the test flow of the end-to-end network probe system; identify from the one or more hop addresses a first hop address associated with the source edge device; in response to identifying a match of the first hop address, identify from the one or more hop addresses a next hop address; upon determining that the next hop address is a last hop, verifying that the last hop includes an IP address matching the destination edge device; and merging the one or more hop addresses into the network path of the test flow of the SD-WAN session, wherein the network path is merged and utilized to generate the end-to-end visualization.

In some aspects, the techniques described herein relate to a method, wherein the test information is collected from one or more agents of the end-to-end network probe system that are monitoring the traffic flow.

In some aspects, the techniques described herein relate to a method, wherein the one or more flow identifiers includes one or more of a test name, test type, a test target URL, test source agent internet protocol (IP) address, test target agent IP address, and test target port.

In some aspects, the techniques described herein relate to a method, wherein the test information includes of one or more network path identifiers including a target URL identifying a destination of the traffic flow.

In some aspects, the techniques described herein relate to a method, wherein the test information includes one or more of jitter, loss, and latency between one or more SD-WAN edge devices.

In one aspect, the techniques described herein relate to a network device including: one or more memories having computer-readable instructions stored therein; and one or more processors configured to execute the computer-readable instructions to: querying, by a path insight tool, an end-to-end network probe system to obtain test information about a traffic flow originating from an endpoint outside a software defined wide area network (SD-WAN) by the end-to-end network probe system, the test information including one or more flow identifiers; identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path; identify a flow identifier that identifies the traffic flow in the end-to-end network probe system; in response to identifying the flow identifier, associating the test information about the traffic flow from the end-to-end network probe system with the statistics associated with the traffic flow obtained as the traffic flow traversed the SD-WAN underlay path; and generating an end-to-end visualization from the test information from the end-to-end network probe system and the statistics associated with the traffic flow as it traversed the SD-WAN underlay path.

In one aspect, the techniques described herein relate to a non-transitory computer-readable storage medium including computer-readable instructions, which when executed by one or more processors of a network appliance, cause the network appliance to: querying, by a path insight tool, an end-to-end network probe system to obtain test information about a traffic flow originating from an endpoint outside a software-defined wide area network (SD-WAN) by the end-to-end network probe system, the test information including one or more flow identifiers; identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path; identify a flow identifier that identifies the traffic flow in the end-to-end network probe system; in response to identifying the flow identifier, associating the test information about the traffic flow from the end-to-end network probe system with the statistics associated with the traffic flow obtained as the traffic flow traversed the SD-WAN underlay path; and generating an end-to-end visualization from the test information from the end-to-end network probe system and the statistics associated with the traffic flow as it traversed the SD-WAN underlay path.

### EXAMPLE EMBODIMENTS

Additional features and advantages of the disclosure will be set forth in the description which follows, and in part will be apparent from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Network applications utilized in an SD-WAN network empower network operators with a suite of tools designed for network monitoring and troubleshooting. These tools provide deep insights and detailed metrics for the SD-WAN network segment. In some examples, network applications provide end-to-end network visibility. By deploying agents in remote locations of an enterprise network and generating synthetic traffic, the network application can effectively visualize the entire network path from hosts to the cloud and measure end-to-end metrics. Thus, the network application allows network operators to gain a clear and detailed understanding of network performance across diverse environments.

However, while network applications can deliver network data for routes that packet travel, they often fail to provide SD-WAN performance data because the underlay of the network is abstracted by the SD-WAN. Thus, monitoring network applications often falls short of providing an end-to-end overview or comprehensive metrics for the entire network traversed by application traffic when a segment of that network is part of an SD-WAN. This is caused by an inability to combine data from a network monitoring application with data from the SD-WAN network.

The proposed solution addresses the above challenges by recognizing synthetic flows from network applications outside the SD-WAN network and collecting data on the synthetic flows as they traverse the SD-WAN network. The proposed technology identifies flows sent by client application agents for specific tests, providing detailed insights into end-to-end network metrics and paths measured by those tests.

On the SD-WAN side, a path insight tool uses measurement capabilities within the SD-WAN to collect data on the SD-WAN session each flow takes. This enables the identification of SD-WAN edge routers in the network path, the underlay hops between these routers, and the flow's network metrics as it moves through the SD-WAN segment. By combining information from both elements, it provides a comprehensive view of the impact of the SD-WAN network on end-to-end metrics and application performance. This integration offers an understanding of network paths within the SD-WAN network, as monitored by client application agents, covering both SD-WAN overlays and previously unseen SD-WAN underlays.

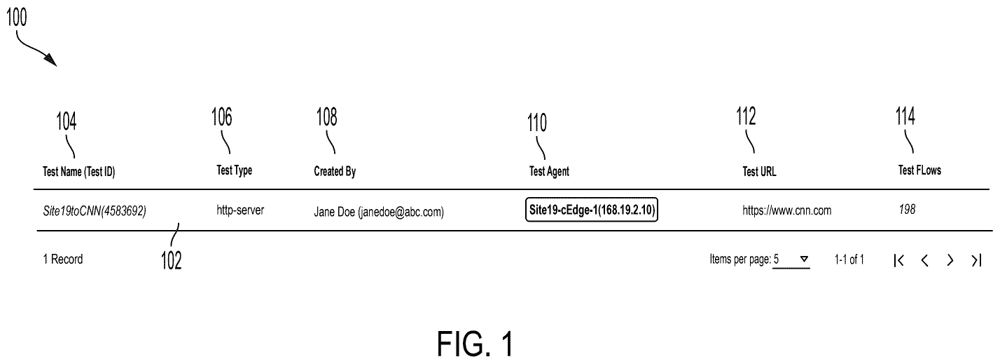

FIG. 1 illustrates an example test setup for collecting SD-WAN traffic information by one or more end-to-end network probe system agents according to some aspects of the present technology.

The end-to-end network probe system is a cloud-based network intelligence platform that provides visibility of traffic flows along multiple network paths by monitoring and analyzing network performance in a network environment. The end-to-end network probe system deploys agents throughout the network to conduct detailed path analyses, measuring key metrics such as latency, jitter, and packet loss across internet, cloud, and enterprise environments.

The end-to-end network probe system can probe the network to collect data from different sources through the deployed agents installed on various endpoints, devices in an enterprise network, and SD-WAN devices. The agents can generate and deploy tests, including synthetic traffic, to monitor flows within the network.

As shown in FIG. 1, the path insight tool can utilize a network insight tool to query the end-to-end network probe system to receive test records 100 including test information. The test information 102 can include a test list that includes a test name and identifier 104, test type 106, test creator 108, test agent 110, test target URL 112, and test flow identifier 114, in addition to a test source agent internet protocol (IP) address, test target agent IP address, and a test target port.

The path insight tool uses the network insight tool to receive test information 102 to construct a mapping table with an end-to-end network probe system flow key and end-to-end network probe system test flow identifier. Within the mapping table, the centralized management platform can indicate the test flow identifiers 114 obtained from the end-to-end network probe system for various test types to ensure precise monitoring and analysis of network performance along multiple network paths.

For HTTP-Server Tests and Agent-to-Server Tests, end-to-end network probe system identifiers can include the IP address of the test source agent and the Fully Qualified Domain Name (FQDN) extracted from the URL of the test target. Additionally, test flow identifiers 114 enable accurate tracking of network interactions between the source agent and the server. In the case of Agent-to-Agent Tests and Voice Tests, the end-to-end network probe system uses the IP address of both the test source and target agents, along with the port of the test target URL 112.

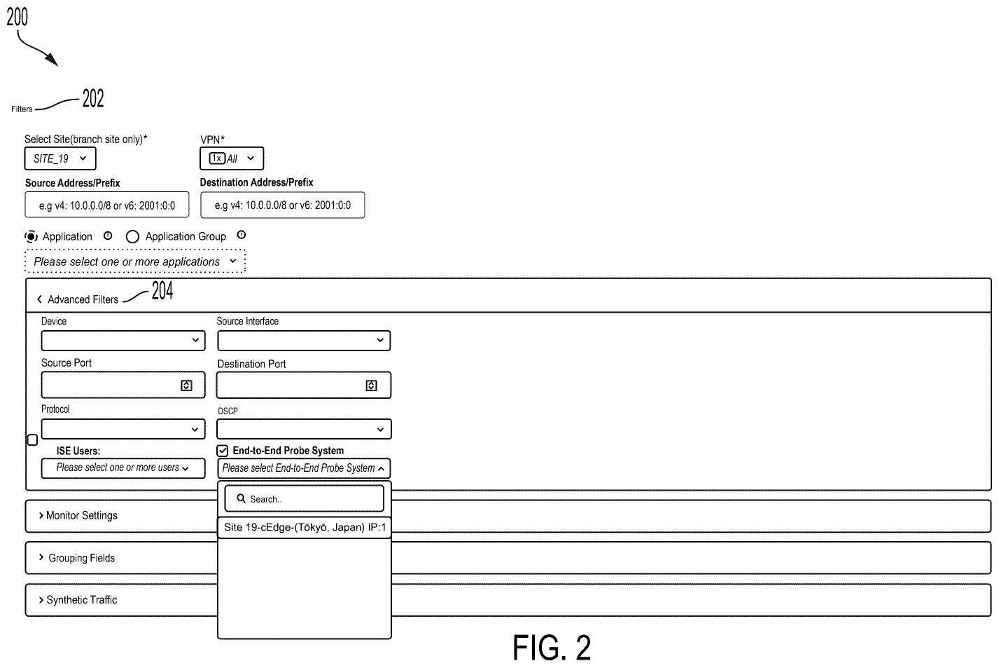

FIG. 2 illustrates an example user interface for a path insight tool 200 to receive filter configurations to filter monitored traffic flows in a network according to some aspects of the present technology.

The path insight tool 200 is utilized to configure the filters 202 to distinguish monitored traffic flows from synthetic traffic generated by end-to-end probe system agents. The path insight tool 200 allows administrators or integrated software-based management tools to input multiple configurations to query the end-to-end network probe system for test information associated with one or more test flows currently being monitored. The user interface can include filters 202 such as branch site selection, source agent identification, and specification of the virtual private network (VPN) associated with the test information to be queried. Additionally, the filters 202 allow for identifying the destination agent. Another set of filters within the user interface can accept inputs specifying an application or application group associated with the test information. This feature enables network administrators to focus on particular network flows related to specific applications, providing granular control and insights.

The path insight tool 200 also incorporates advanced filters 204, enhancing the capability to specify precise criteria for querying detailed test flow information from the end-to-end network probe system. These advanced filters 204 enable selection options such as network device, source interface, source port, destination port, protocol, Differentiated Services Code Point (DSCP), Identity Services Engine Users (ISE Users), and a designated agent of the end-to-end network probe system.

Conversely, monitoring configurations differ if the end-to-end network probe system agent is not hosted on SD-WAN edge devices, where more specific filter configurations can be implemented. After the configurations have been specified, the path insight tool 200 can perform monitoring of test flows of the end-to-end network probe system agents based on the selected configurations indicated by the filters 202. When the filters 202 are configured, the path insight tool 200 specifically focuses on monitoring traffic originating from designated end-to-end network probe system agent IP addresses, providing targeted insights into those specific flows. In contrast, without a filter configured, the tool monitors all network traffic in a more generalized manner.

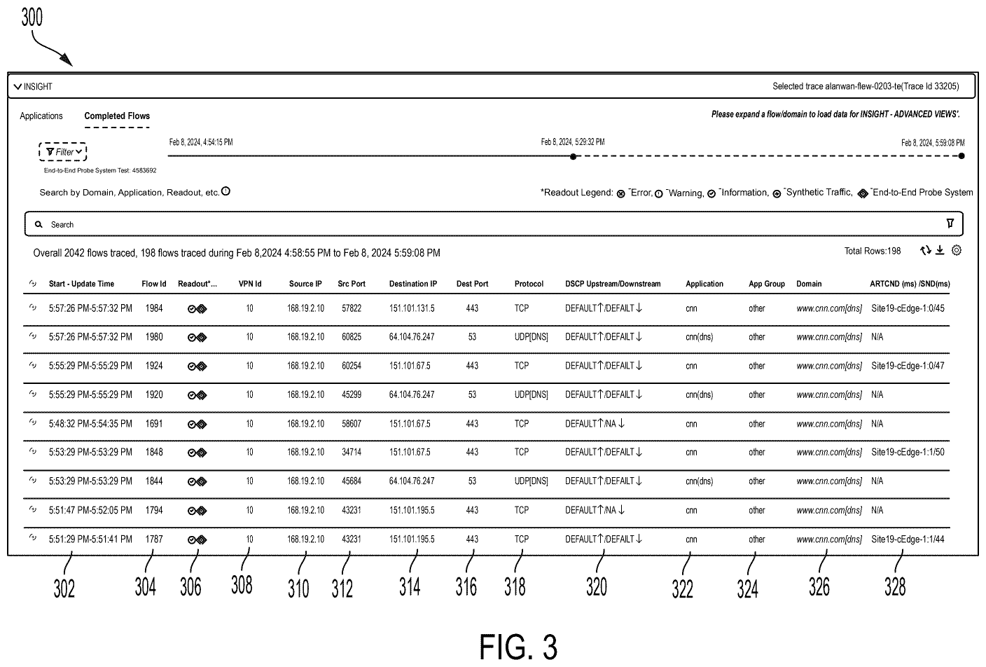

FIG. 3 illustrates a collection of traffic flow information 300 gathered by one or more agents of the end-to-end network probe system and presented in the path insight tool according to some aspects of the present technology.

The collection of traffic flow information 300 encompasses various data points obtained from test flows monitored by agents within the end-to-end network probe system. This collection of traffic flow information 300 is subsequently transmitted to the path insight tool for further analysis and processing. This data encompasses the time of the traced flow 302, flow identifier 304, network application monitoring the traced flow 306, VPN ID 308, source IP address 310, source port location 312, destination IP address 314, destination port location 316, network protocol 318, DSCP upstream and downstream configuration 320, traced flow application 322, traced flow application group 324, domain address 326, and ART CND/SND 328.

In an example, the end-to-end network probe system agents can collect traffic flow information for the deployed tests and report the traffic flow information to the path insight tool for centralized management, analysis, and further monitoring. The traffic flow information can include capturing flow tuples containing source and destination IP addresses, as well as source and destination ports, ensuring detailed data collection for each flow. The device also records specifics regarding the SD-WAN session to which each flow is forwarded, providing insights into network paths and session management.

Flow metrics such as jitter, loss, and latency between the end-to-end network probe system agents are measured to evaluate network performance and reliability. For DNS flows, the device logs the queried Fully Qualified Domain Name (FQDN) as the destination FQDN, alongside IP addresses obtained from DNS replies. This data is used to construct and maintain IP addresses to the FQDN mapping table within the SD-WAN device, facilitating efficient DNS resolution. In TLS flows, the device extracts the server_name extension from TLS Client Hello messages to determine the destination FQDN, while in HTTP flows, it extracts the host header. In examples where flows are unrecognized, the device uses the flow's destination IP address to query the IP addresses to a FQDN mapping table, thereby identifying the associated destination FQDN.

Once the path insight tool receives the collection of traffic flow information 300 from the end-to-end network probe system agents, the centralized management platform generates a flow matching key using this data. For example, for flows with an identified Fully Qualified Domain Name (FQDN), the matching key includes the source IP address and the destination FQDN. In cases where the flow lacks an identified FQDN, the matching key comprises the source IP address, destination IP address, and destination port. This flow matching key provides the ability to locate the flow identifier 304 corresponding end-to-end probe system within the mapping table, specifically designed to include (<end-to-end network probe system flow key, end-to-end network probe system test identifier>) as structured in the query of FIG. 1.

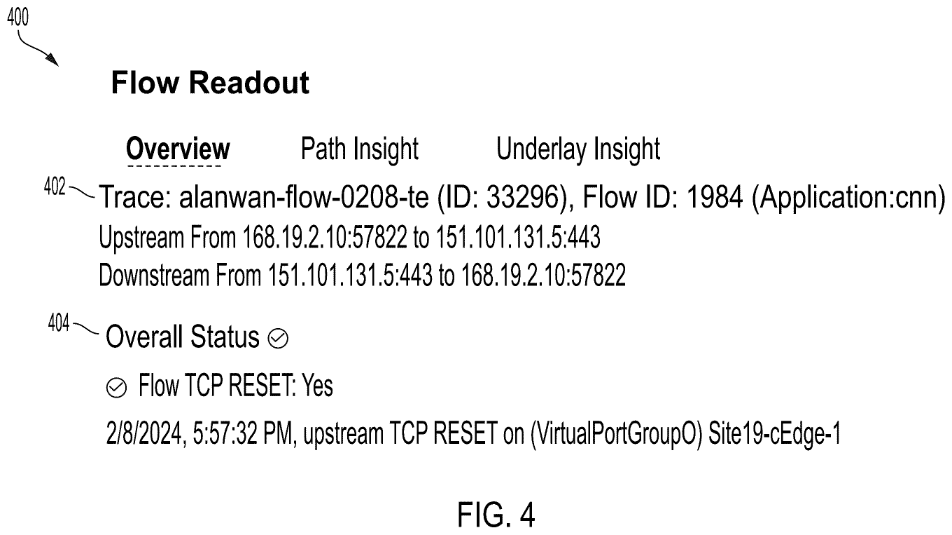

FIG. 4 illustrates an example flow readout from a query of the end-to-end network probe system by a path insight tool according to some aspects of the present technology.

Upon finding a matching key, as discussed in FIG. 3, the path insight tool confirms that the flow corresponds to an end-to-end network probe system test. These tests can be conducted periodically, and each round of tests performed is uniquely identified with test round identifiers. The system identifies the test round identifier closest in time to the flow's timestamp and stores it in a flow database, which subsequently provides a flow readout 400 depicted in FIG. 4. This precise mapping allows for the association of traffic flows with specific rounds of tests performed by agents of the end-to-end network probe system.

As shown in FIG. 4, a flow readout 400 is generated for each monitored flow by an agent of the end-to-end network probe system. This readout includes flow trace information 402, which details the name of the monitored flow, a flow identifier, and the IP addresses linked to both the upstream and downstream network paths of the flow. Additionally, the flow readout 400 provides a status indication 404 for the monitored flow.

Utilizing the matching key allows for the retrieval of network metrics and path information specific to a specified test round. This enables access to pertinent details about the network paths relevant to a particular test round. Aligning each flow with its corresponding test round confirms that both datasets originate from the same end-to-end probe system synthetic test flow. This alignment streamlines the integration of data from both sources, facilitating the ability to combine multiple datasets to develop a visualization of a network path for specified test flows.

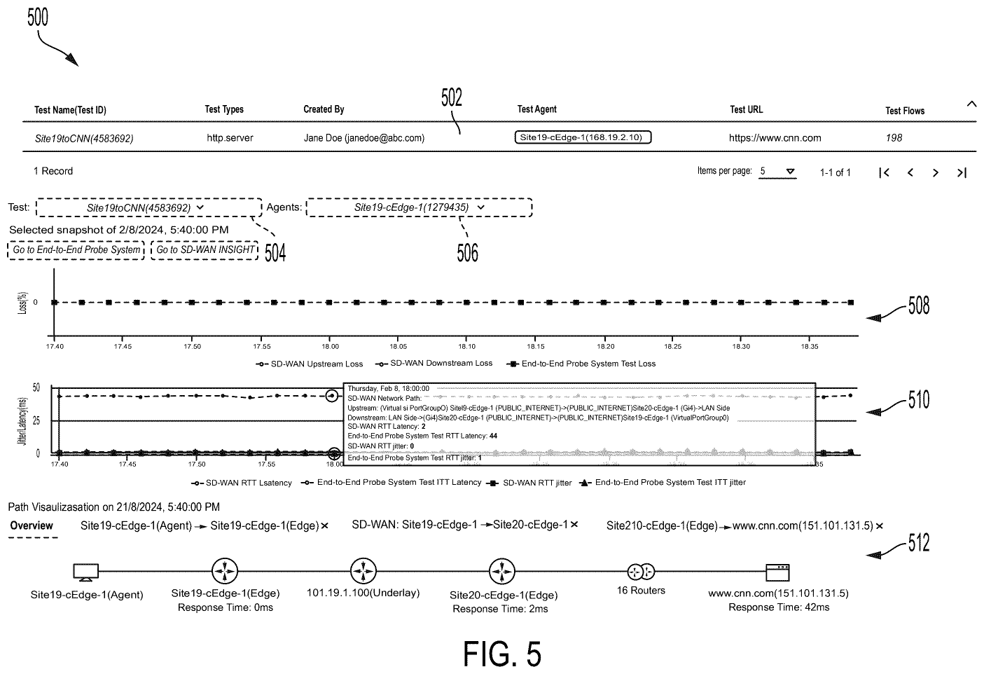

FIG. 5 illustrates an example user interface of the path insight tool depicting test information for a specified traffic flow for tests deployed by the end-to-end network probe system according to some aspects of the present technology.

As illustrated above in FIG. 4, the path insight tool has successfully linked each flow with a specific round of testing conducted by an end-to-end network probe system agent. This connection enables the retrieval of network metrics and path information for that particular test round from the end-to-end network probe system. Moreover, this linkage allows for the acquisition of SD-WAN network segment metrics and session details, including the underlay hop list associated with the test flow. Through this acquisition, the path insight tool can ensure that both datasets originate from measurements targeting the same entity-the end-to-end network probe system synthetic flow that was captured.

As depicted in FIG. 5, upon selecting a test flow within the user interface 500 from the test record 502 in the collection of traffic flow information 300, as shown in FIG. 3, the path insight tool provides test information for one or more monitored traffic flows. This includes details such as the type of test flow 504 being conducted, the specific end-to-end network probe system agent performing the test 506, and network metrics associated with the test execution.

The network metrics provided include latency metrics 508 for SD-WAN upstream and downstream loss and specific end-to-end network probe system test loss metrics. Additionally, the network metrics cover a jitter/latency comparison 510 that contrasts latency and jitter measurements for SD-WAN Round-Trip Time (RTT) and end-to-end network probe system RTT, providing insights into network performance along various network paths.

The user interface 500 also features a path visualization 512 linked to the test record 502. The path visualization 512 provides a graphical representation of the test flow's path, starting from the originating agent (site19-cEdge-1) and extending to the destination IP address (151.101.131.5 associated with “cnn.com”). Within path visualization 512, network devices, including SD-WAN edge devices and other components along the data path, are indicated. For example, the depicted network path includes the first SD-WAN edge device (site19-cEdge-1), an underlay device (101.19.1.100), a second SD-WAN edge device (site20-cEdge-1), and 16 routers before reaching the destination IP address.

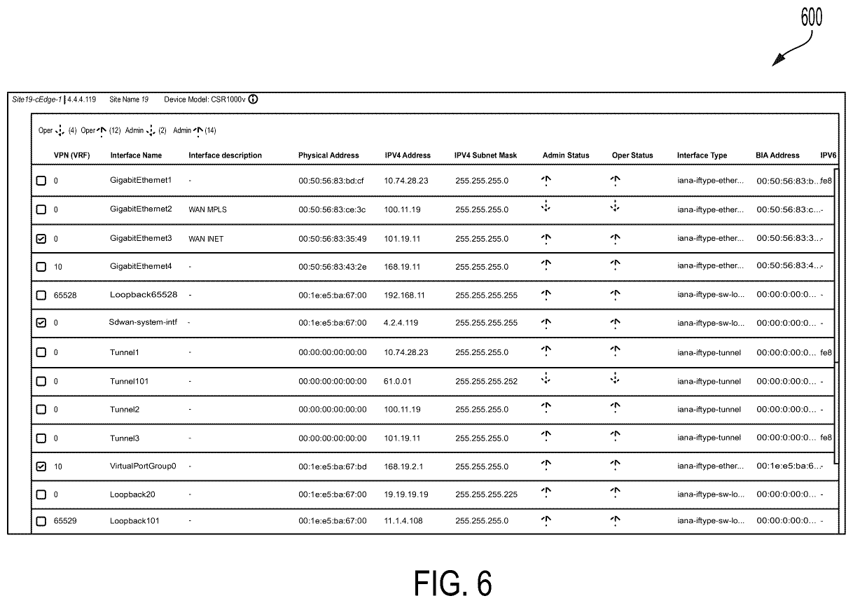

The path insight tool can further identify SD-WAN edge routers within the path visualization 512 of the end-to-end network probe system. The subsequent discussion of FIG. 6-FIG. 8B details the steps that can be taken to integrate the SD-WAN underlay network hop list into the path visualization 512 hop list of the end-to-end network probe system.

FIG. 6 illustrates an example view from a database storing SD-WAN edge device information according to some aspects of the present disclosure.

As previously discussed in FIG. 5, the path insight tool has received information about SD-WAN edge devices in a hop list for the end-to-end network probe system path visualization for a specific test round, including details of the SD-WAN session used in that round and the hop list of the underlay path for that session. However, another data source is needed to merge the SD-WAN underlay hops into the end-to-end network probe system path visualization. A database 600 stored on the centralized management platform, containing information about the SD-WAN edge devices in the network, can be utilized to integrate the SD-WAN underlay hop device information into the end-to-end network probe system path visualization.

The database 600 comprises traffic flow information collected from SD-WAN edge devices. This information includes a list of interfaces and their associated source and destination IP addresses. Database 600 features multiple entries related to traffic flows monitored at an SD-WAN edge device. The recorded traffic flow information encompasses VPN identification, interface name, interface description, physical address, IPv4 address, IPv4 subnet mask, administrative status, operational status, interface type, and BIA address.

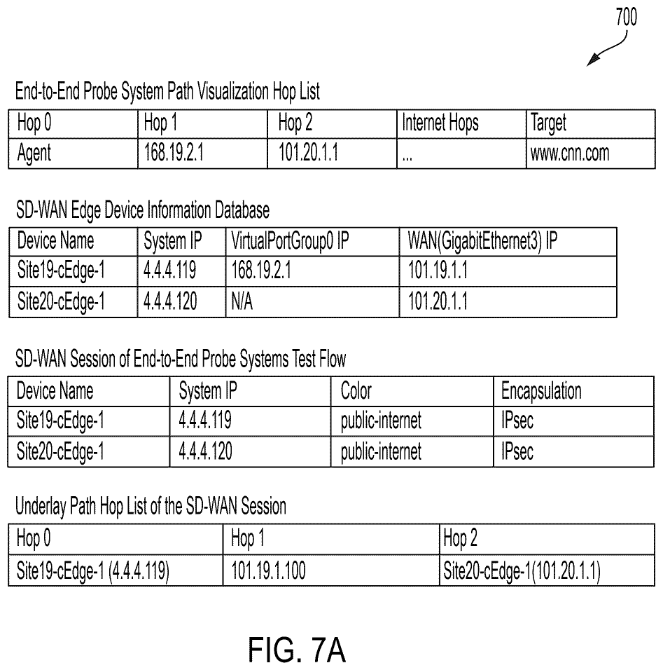

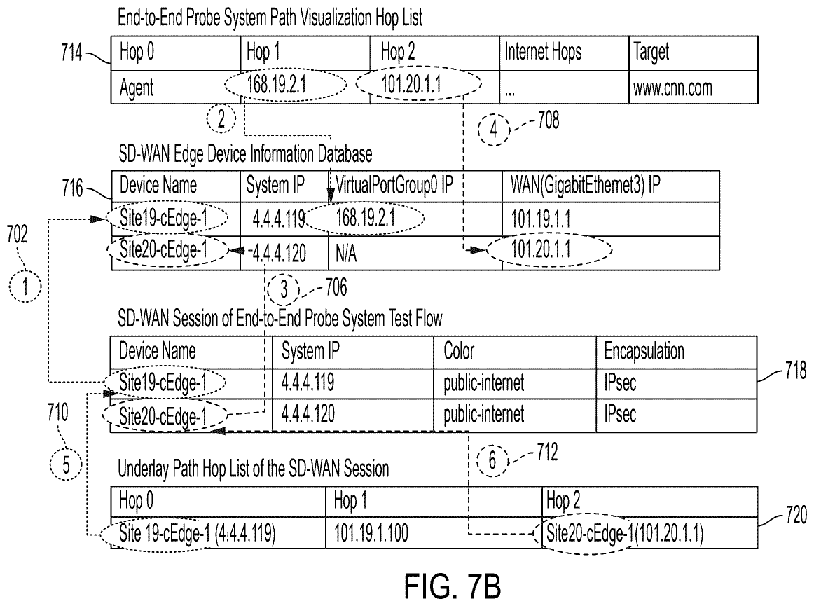

The path insight tool can extract relevant traffic flow information from database 600 and identify an underlying path hop list that merges the SD-WAN underlay network hop list into the end-to-end network probe system path visualization hop list, as shown in FIG. 7A.

FIG. 7A illustrates extracted information 700 from the database of SD-WAN edge devices for mapping of the traffic flows according to some aspects of the disclosure.

The traffic flow information can be extracted from the database 600 in FIG. 6, using traceroute or an equivalent method to obtain flow data, allowing the system to identify visible IP addresses. These IP addresses can correspond to the interfaces that receive the traceroute probes on the device. In some examples, both local area network (LAN), and wide area network (WAN) interfaces of a device can be used, and there is no specific IP address representing the entire device. The database 600, shown in FIG. 6, allows for the avoidance of mismatches between the IP address used for an SD-WAN edge device in the session and the traceroute path list. Mismatches are prevented by utilizing a system IP from an SD-WAN session serves as a key to look up the device information database, retrieving a complete list of interfaces and IP addresses for that device. The IP addresses from the end-to-end network probe system path hop list are then used to cross-reference the device's IP addresses. If a match is found, whether a particular end-to-end network probe system hop is an SD-WAN edge device is determined. The following discussion with regard to FIG. 7B provides additional details related to this process.

FIG. 7B illustrates a mapping SD-WAN edge device and trace route path information extracted from the database according to some aspects of the disclosure.

The process of mapping SD-WAN edge device and traceroute path information extracted from the database involves a series of steps. In step 702, the path insight tool identifies that the SD-WAN session of the end-to-end network probe system test flow 718 uses an SD-WAN session from Site19-cEdge-1 (4.4.4.119) to Site20-cEdge-1 (4.4.4.120). The path insight tool then looks up Site19-cEdge-1 in the SD-WAN edge device information database 716 to extract the associated IP address list, which includes 4.4.4.119, 168.19.2.1, and 101.19.1.1.

In step 704, the path insight tool identifies which hop in the end-to-end network probe system path visualization hop list 714 corresponds to Site19-cEdge-1. The path insight tool uses the first hop IP address, 168.19.2.1, to search Site19-cEdge-1's IP address list. Upon finding a match, it determines that hop 1 is Site19-cEdge-1. If no match is found, the tool continues with the next hop IP address in the path visualization hop list. As shown in FIG. 7B, a match is found, and the path insight tool confirms that hop 1 is Site19-cEdge-1.

In step 706, the path insight tool verifies the remote peer of the SD-WAN session of the end-to-end network probe system test flow 718 by repeating the process for Site20-cEdge-1 (4.4.4.120). The path insight tool retrieves the IP address list for Site20-cEdge-1, which includes 4.4.4.120 and 101.20.1.1.

In step 708, the path insight tool uses the next hop IP address, 101.20.1.1, to repeat step 704. If a match is found, the path insight tool confirms that hop 2 is Site20-cEdge-1; if not, the process is aborted due to data source misalignment. As shown in FIG. 7B, a match is found, and the path insight tool determines that hop 2 is Site20-cEdge-1.

In step 710, the path insight tool extracts hop information from the underlay path hop list of the SD-WAN session 720 used by the SD-WAN session of the end-to-end network probe system test flow 718. A sanity check is performed to verify that the beginning node of the underlay path hop list of the SD-WAN session 720 matches Site19-cEdge-1. If a match is found, the path insight tool proceeds to verify the ending node of the underlay path; if a mismatch is detected, the process is aborted due to misalignment with the target SD-WAN session. In the example shown in FIG. 7B, the sanity check passes.

In step 712, a sanity check is performed on the ending node of the underlay path hop list of the SD-WAN session 720 to verify it matches Site20-cEdge-1. If a match is found, the hops from the underlay path hop list of the SD-WAN session 720 are inserted into the end-to-end network probe system path visualization, excluding the beginning, and ending nodes as they already appear in the visualization. If a mismatch is detected, the process is aborted due to misalignment with the target SD-WAN session.

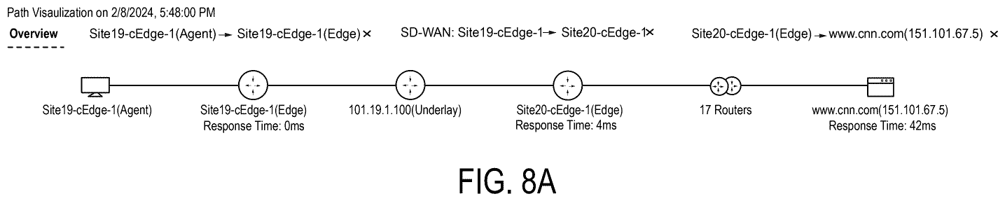

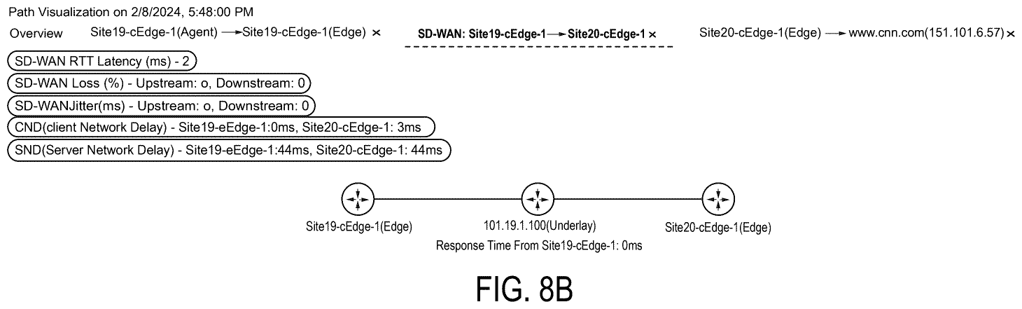

FIG. 8A illustrates a client application visualization in the path insight tool in accordance with the mapping of the SD-WAN edge device and traceroute path information extracted from the database according to some aspects of the disclosure.

After processing the steps outlined in FIG. 7B, a complete path visualization is generated as shown in FIG. 8A. FIG. 8B illustrates all the SD-WAN edge routers marked along the path. The completed hop list is supplemented with SD-WAN underlay hops. Additionally, the visualization displays all SD-WAN session network metrics for data enrichment.

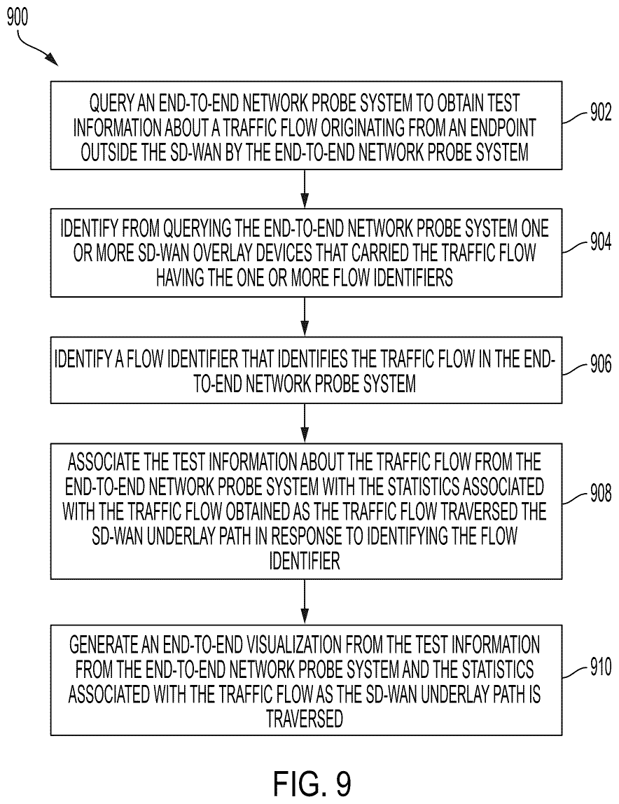

FIG. 9 illustrates an example process for identifying an end-to-end data path and associated statistics for traffic flows that traverse a software-defined wide area network (SD-WAN) and that originate or terminate outside the SD-WAN according to some aspects of the disclosure. Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at the same time or in a specific sequence.

According to some examples, the process 900 includes querying an end-to-end network probe system to obtain test information about a traffic flow originating from an endpoint outside the SD-WAN by the end-to-end network probe system at block 902. For example, the path insight tool 200 illustrated in FIG. 2 may query an end-to-end network probe system to obtain test information about a traffic flow originating from an endpoint outside the SD-WAN by the end-to-end network probe system. The test information includes one or more flow identifiers that include one or more of a test name, test type, a test target URL, test source agent internet protocol (IP) address, test target agent IP address, and test target port. The path insight tool 200 can further determine that the test information comprises a target uniform resource locator (URL). The test information can comprise one or more network path identifiers, including a target URL identifying a destination of the traffic flow. The test information can include one or more of jitter, loss, and latency metrics between one or more SD-WAN edge devices. The path insight tool 200 can generate an end-to-end network probe system flow key from one or more flow identifiers, including a source agent IP address and a test target FQDN. The path insight tool 200 can determine that the test information does not include a target URL. The path insight tool 200 can generate an end-to-end network probe system flow key from one or more flow identifiers, including one or more of a source agent IP address, a test target agent IP address, a destination FQDN, or a test target port. The path insight tool 200 can further construct the test information received from the end-to-end network probe system in a mapping table comprising the one or more flow identifiers of tests associated with the test information.

According to some examples, the method includes identifying from querying the end-to-end network probe system one or more SD-WAN overlay devices that carried the traffic flow having the one or more flow identifiers at block 904. For example, the path insight tool 200 illustrated in FIG. 2 may identify from querying the end-to-end network probe system one or more SD-WAN overlay devices that carried the traffic flow having the one or more flow identifiers. The one or more SD-WAN overlay devices are translated into an SD-WAN underlay path through the SD-WAN, and statistics associated with the traffic flow are obtained as the traffic flow traverses the SD-WAN underlay path. The end-to-end network probe system comprises one or more agents on one or more SD-WAN edge devices, where the path insight tool is configured to monitor the traffic flow from the one or more agents.

According to some examples, the method includes identifying a flow identifier that identifies the traffic flow in the end-to-end network probe system at block 906. For example, the path insight tool 200 illustrated in FIG. 2 may identify a flow identifier that identifies the traffic flow in the end-to-end network probe system. The path insight tool is configured to monitor the traffic flows having the flow identifier by the path insight tool. The path insight tool is further configured to collect one or more sample data packets from the traffic flow when concurrent traffic flows exceed a predetermined scale limit.

According to some examples, the method includes associating the test information about the traffic flow from the end-to-end network probe system with the statistics associated with the traffic flow obtained as the traffic flow traversed the SD-WAN underlay path in response to identifying the flow identifier at block 908. For example, the path insight tool 200 illustrated in FIG. 2 may associate the test information about the traffic flow from the end-to-end network probe system with the statistics associated with the traffic flow obtained as the traffic flow traversed the SD-WAN underlay path in response to identifying the flow identifier.

According to some examples, the method includes generating an end-to-end visualization from the test information from the end-to-end network probe system and the statistics associated with the traffic flow as the SD-WAN underlay path is traversed at block 910. For example, the path insight tool 200 illustrated in FIG. 2 may generate an end-to-end visualization from the test information from the end-to-end network probe system and the statistics associated with the traffic flow as the SD-WAN underlay path is traversed. Generating the end-to-end visualization involves identifying one or more Internet Protocol (IP) addresses associated with a test flow of an SD-WAN session between a source edge device and a destination edge device. These IP addresses include one or more hop addresses along the network path of the test flow of the end-to-end network probe system. Generating the end-to-end visualization further includes identifying from the one or more hop addresses a first hop address associated with the source edge device. In response to identifying a match for the first hop address, the process involves identifying from the one or more hop addresses the next hop address. Upon determining that the next hop address is the last hop, it verifies that the last hop includes an IP address matching the destination edge device. Additionally, generating the end-to-end visualization involves merging the one or more hop addresses into the network path of the test flow of the SD-WAN session, utilizing the merged network path to create the end-to-end visualization.

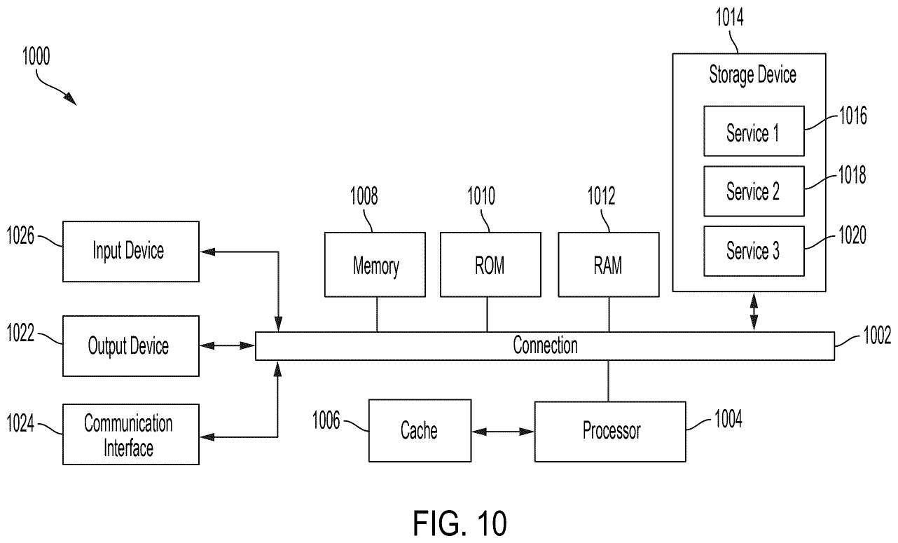

FIG. 10 shows an example of computing system 1000, which can be for example any computing device making up a system network, or any component thereof in which the components of the system are in communication with each other using connection 1002. Connection 1002 can be a physical connection via a bus, or a direct connection into processor 1004, such as in a chipset architecture. Connection 1002 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1000 includes at least one processing unit (central processing unit (CPU) or processor) and connection 1002 that couples various system components including system memory 1008, such as read-only memory (ROM) 1010 and random access memory (RAM) 1012 to processor 1004. Computing system 1000 can include a cache 1006 of system memory 1008 connected directly with, in close proximity to, or integrated as part of processor 1004.

Processor 1004 can include any general-purpose processor and a hardware service or software service, such as services 1016, 1018, and 1020 stored in storage device 1014, configured to control processor 1004 as well as a special-purpose processor where software instructions are incorporated into the actual processor design. Processor 1004 may essentially be a completely self-contained computing system, containing multiple cores or processors, a bus, memory controller, cache 1006, etc. A multi-core processor may be symmetric or asymmetric.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

Storage device 1014 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1014 can include software services, servers, services, etc., that when the code that defines such software is executed by the processor 1004, it causes the system to perform a function. In some embodiments, a hardware service that performs a particular function can include the software component stored in a computer-readable medium in connection with the hardware components, such as processor 1004, connection 1002, output device 1022, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Although a variety of examples and other information was used to explain embodiments within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some clauses of the present technology include:

Clause 1. A method for identifying an end-to-end data path and associated statistics for traffic flows that traverse a software-defined wide area network (SD-WAN) and that originate or terminate outside the SD-WAN, the method comprising: querying, by a path insight tool, an end-to-end network probe system to obtain test information about a traffic flow originating from an endpoint outside the SD-WAN by the end-to-end network probe system, the test information including one or more flow identifiers; identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path; identify a flow identifier that identifies the traffic flow in the end-to-end network probe system; in response to identifying the flow identifier, associating the test information about the traffic flow from the end-to-end network probe system with the statistics associated with the traffic flow obtained as the traffic flow traversed the SD-WAN underlay path; and generating an end-to-end visualization from the test information from the end-to-end network probe system and the statistics associated with the traffic flow as it traversed the SD-WAN underlay path.

Clause 2. The method of clause 1, further comprising: determining that the test information comprises a target uniform resource locator (URL); and generating an end-to-end network probe system flow key from the one or more flow identifiers including a source agent IP address and a test target FQDN.

Clause 3. The method of clause 1, further comprising: determining that the test information does not include a target uniform resource locator (URL); and generating an end-to-end network probe system flow key from the one or more flow identifiers including one or more of a source agent IP address, a test target agent IP address, a destination FQDN or a test target port.

Clause 4. The method of clause 1, wherein the end-to-end network probe system comprises of one or more agents on one or more SD-WAN edge devices, wherein the path insight tool is configured to monitor the traffic flow from the one or more agents.

Clause 5. The method of clause 1, wherein the path insight tool is configured to: monitor the traffic flows having the flow identifier by the path insight tool; or collect one or more sample data packets from the traffic flow when concurrent traffic flows exceeds a predetermined scale limit.

Clause 6. The method of clause 1, further comprising: constructing the test information received from the end-to-end network probe system in a mapping table comprising the one or more flow identifiers of tests associated with the test information.

Clause 7. The method of clause 1, wherein generating the end-to-end visualization comprises: identifying one or more internet protocol addresses associated with a test flow of an SD-WAN session between a source edge device and a destination edge device, the one or more internet protocol addresses including one or more hop addresses along a network path of the test flow of the end-to-end network probe system; identify from the one or more hop addresses a first hop address associated with the source edge device; in response to identifying a match of the first hop address, identify from the one or more hop addresses a next hop address; upon determining that the next hop address is a last hop, verifying that the last hop includes an IP address matching the destination edge device; and merging the one or more hop addresses into the network path of the test flow of the SD-WAN session, wherein the network path is merged and utilized to generate the end-to-end visualization.

Clause 8. The method of clause 1, wherein the test information is collected from one or more agents of the end-to-end network probe system that are monitoring the traffic flow.

Clause 9. The method of clause 1, wherein the one or more flow identifiers includes one or more of a test name, test type, a test target URL, test source agent internet protocol (IP) address, test target agent IP address, and test target port.

Clause 10. The method of clause 1, wherein the test information comprises of one or more network path identifiers including a target URL identifying a destination of the traffic flow.

Clause 11. The method of clause 1, wherein the test information includes one or more of jitter, loss, and latency between one or more SD-WAN edge devices.

Clause 12. A network device comprising: one or more memories having computer-readable instructions stored therein; and one or more processors configured to execute the computer-readable instructions to: querying, by a path insight tool, an end-to-end network probe system to obtain test information about a traffic flow originating from an endpoint outside a software defined wide area network (SD-WAN) by the end-to-end network probe system, the test information including one or more flow identifiers; identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path; identify a flow identifier that identifies the traffic flow in the end-to-end network probe system; in response to identifying the flow identifier, associating the test information about the traffic flow from the end-to-end network probe system with the statistics associated with the traffic flow obtained as the traffic flow traversed the SD-WAN underlay path; and generating an end-to-end visualization from the test information from the end-to-end network probe system and the statistics associated with the traffic flow as it traversed the SD-WAN underlay path.

Clause 13. The network device of clause 12, wherein the computer-readable instructions further cause the one or more processors to: determining that the test information comprises a target uniform resource locator (URL); and generating an end-to-end network probe system flow key from the one or more flow identifiers including a source agent IP address and a test target FQDN.

Clause 14. The network device of clause 12, wherein the computer-readable instructions further cause the one or more processors to: determining that the test information does not include a target uniform resource locator (URL); and generating an end-to-end network probe system flow key from the one or more flow identifiers including one or more of a source agent IP address, a test target agent IP address, a destination FQDN or a test target port.

Clause 15. The network device of clause 12, wherein the end-to-end network probe system comprises of one or more agents on one or more SD-WAN edge devices, wherein the path insight tool is configured to monitor the traffic flow from the one or more agents.

Clause 16. The network device of clause 12, wherein the path insight tool is configured to: monitor the traffic flow having the flow identifier by the path insight tool; or collect one or more sample data packets from the traffic flow when concurrent traffic flows exceeds a predetermined scale limit.

Clause 17. The network device of clause 12, wherein the computer-readable instructions further cause the one or more processors to: constructing the test information received from the end-to-end network probe system in a mapping table comprising the one or more flow identifiers of tests associated with the test information.

Clause 18. The network device of clause 12, wherein generating the end-to-end visualization comprises: identifying one or more internet protocol addresses associated with a test flow of an SD-WAN session between a source edge device and a destination edge device, the one or more internet protocol addresses including one or more hop addresses along a network path of the test flow of the end-to-end network probe system; identify from the one or more hop addresses a first hop address associated with the source edge device; in response to identifying a match of the first hop address, identify from the one or more hop addresses a next hop address; upon determining that the next hop address is a last hop, verifying that the last hop includes an IP address matching the destination edge device; and merging the one or more hop addresses into the network path of the test flow of the SD-WAN session, wherein the network path is merged and utilized to generate the end-to-end visualization.

Clause 19. The network device of clause 12, wherein the test information is collected from one or more agents of the end-to-end network probe system that are monitoring the traffic flow.

Clause 20. The network device of clause 12, wherein the one or more flow identifiers includes one or more of a test name, test type, a test target URL, test source agent internet protocol (IP) address, test target agent IP address, and test target port.

Clause 21. The network device of clause 12, wherein the test information comprises of one or more network path identifiers including a target URL identifying a destination of the traffic flow.

Clause 22. The network device of clause 12, wherein the test information includes one or more of jitter, loss, and latency between one or more SD-WAN edge devices.

Clause 23. A non-transitory computer-readable storage medium comprising computer-readable instructions, which when executed by one or more processors of a network appliance, cause the network appliance to: querying, by a path insight tool, an end-to-end network probe system to obtain test information about a traffic flow originating from an endpoint outside a software-defined wide area network (SD-WAN) by the end-to-end network probe system, the test information including one or more flow identifiers; identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path; identify a flow identifier that identifies the traffic flow in the end-to-end network probe system; in response to identifying the flow identifier, associating the test information about the traffic flow from the end-to-end network probe system with the statistics associated with the traffic flow obtained as the traffic flow traversed the SD-WAN underlay path; and generating an end-to-end visualization from the test information from the end-to-end network probe system and the statistics associated with the traffic flow as it traversed the SD-WAN underlay path.

Clause 24. The non-transitory computer-readable storage medium of clause 23, wherein the one or more processors are further configured to: determining that the test information comprises a target uniform resource locator (URL); and generating an end-to-end network probe system flow key from the one or more flow identifiers including a source agent IP address and a test target FQDN.

Clause 25. The non-transitory computer-readable storage medium of clause 23, wherein the one or more processors are further configured to: determining that the test information does not include a target uniform resource locator (URL); and generating an end-to-end network probe system flow key from the one or more flow identifiers including one or more of a source agent IP address, a test target agent IP address, a destination FQDN or a test target port.

Clause 26. The non-transitory computer-readable storage medium of clause 23, wherein the end-to-end network probe system comprises of one or more agents on one or more SD-WAN edge devices, wherein the path insight tool is configured to monitor the traffic flow from the one or more agents.

Clause 27. The non-transitory computer-readable storage medium of clause 23, wherein the path insight tool is configured to: monitor the traffic flow having the flow identifier by the path insight tool; or collect one or more sample data packets from the traffic flow when concurrent traffic flows exceeds a predetermined scale limit.

Clause 28. The non-transitory computer-readable storage medium of clause 23, wherein the one or more processors are further configured to: constructing the test information received from the end-to-end network probe system in a mapping table comprising the one or more flow identifiers of tests associated with the test information.

Clause 29. The non-transitory computer-readable storage medium of clause 23, wherein generating the end-to-end visualization comprises: identifying one or more internet protocol addresses associated with a test flow of an SD-WAN session between a source edge device and a destination edge device, the one or more internet protocol addresses including one or more hop addresses along a network path of the test flow of the end-to-end network probe system; identify from the one or more hop addresses a first hop address associated with the source edge device; in response to identifying a match of the first hop address, identify from the one or more hop addresses a next hop address; upon determining that the next hop address is a last hop, verifying that the last hop includes an IP address matching the destination edge device; and merging the one or more hop addresses into the network path of the test flow of the SD-WAN session, wherein the network path is merged and utilized to generate the end-to-end visualization.

Clause 30. The non-transitory computer-readable storage medium of clause 23, wherein the test information is collected from one or more agents of the end-to-end network probe system that are monitoring the traffic flow.

Clause 31. The non-transitory computer-readable storage medium of clause 23, wherein the one or more flow identifiers includes one or more of a test name, test type, a test target URL, test source agent internet protocol (IP) address, test target agent IP address, and test target port.

Clause 32. The non-transitory computer-readable storage medium of clause 23, wherein the test information comprises of one or more network path identifiers including a target URL identifying a destination of the traffic flow.

Clause 33. The non-transitory computer-readable storage medium of clause 23, wherein the test information includes one or more of jitter, loss, and latency between one or more SD-WAN edge devices.

What is claimed is:

1. A method for identifying an end-to-end data path and associated statistics for traffic flows that traverse a software-defined wide area network (SD-WAN) and that originate or terminate outside the SD-WAN, the method comprising:
querying, by a path insight tool, an end-to-end network probe system to obtain test information about a traffic flow originating from an endpoint outside the SD-WAN by the end-to-end network probe system, the test information including one or more flow identifiers;
identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path;
identify a flow identifier that identifies the traffic flow in the end-to-end network probe system;
in response to identifying the flow identifier, associating the test information about the traffic flow from the end-to-end network probe system with the statistics associated with the traffic flow obtained as the traffic flow traversed the SD-WAN underlay path; and
generating an end-to-end visualization from the test information from the end-to-end network probe system and the statistics associated with the traffic flow as it traversed the SD-WAN underlay path.

2. The method of claim 1, further comprising:
determining that the test information comprises a target uniform resource locator (URL); and
generating an end-to-end network probe system flow key from the one or more flow identifiers including a source agent IP address and a test target FQDN.

3. The method of claim 1, further comprising:
determining that the test information does not include a target uniform resource locator (URL); and
generating an end-to-end network probe system flow key from the one or more flow identifiers including one or more of a source agent IP address, a test target agent IP address, a destination FQDN or a test target port.

4. The method of claim 1, wherein the end-to-end network probe system comprises of one or more agents on one or more SD-WAN edge devices, wherein the path insight tool is configured to monitor the traffic flow from the one or more agents.

5. The method of claim 1, wherein the path insight tool is configured to:
monitor the traffic flows having the flow identifier by the path insight tool; or
collect one or more sample data packets from the traffic flow when concurrent traffic flows exceeds a predetermined scale limit.

6. The method of claim 1, further comprising:
constructing the test information received from the end-to-end network probe system in a mapping table comprising the one or more flow identifiers of tests associated with the test information.

7. The method of claim 1, wherein generating the end-to-end visualization comprises:
identifying one or more internet protocol addresses associated with a test flow of an SD-WAN session between a source edge device and a destination edge device, the one or more internet protocol addresses including one or more hop addresses along a network path of the test flow of the end-to-end network probe system;
identify from the one or more hop addresses a first hop address associated with the source edge device;
in response to identifying a match of the first hop address, identify from the one or more hop addresses a next hop address;
upon determining that the next hop address is a last hop, verifying that the last hop includes an IP address matching the destination edge device; and
merging the one or more hop addresses into the network path of the test flow of the SD-WAN session, wherein the network path is merged and utilized to generate the end-to-end visualization.

8. A network device comprising:
one or more memories having computer-readable instructions stored therein; and
one or more processors configured to execute the computer-readable instructions to:
querying, by a path insight tool, an end-to-end network probe system to obtain test information about a traffic flow originating from an endpoint outside a software defined wide area network (SD-WAN) by the end-to-end network probe system, the test information including one or more flow identifiers;
identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path;
identify a flow identifier that identifies the traffic flow in the end-to-end network probe system;
in response to identifying the flow identifier, associating the test information about the traffic flow from the end-to-end network probe system with the statistics associated with the traffic flow obtained as the traffic flow traversed the SD-WAN underlay path; and
generating an end-to-end visualization from the test information from the end-to-end network probe system and the statistics associated with the traffic flow as it traversed the SD-WAN underlay path.

9. The network device of claim 8, wherein the computer-readable instructions further cause the one or more processors to:
determining that the test information comprises a target uniform resource locator (URL); and
generating an end-to-end network probe system flow key from the one or more flow identifiers including a source agent IP address and a test target FQDN.

10. The network device of claim 8, wherein the computer-readable instructions further cause the one or more processors to:
determining that the test information does not include a target uniform resource locator (URL); and
generating an end-to-end network probe system flow key from the one or more flow identifiers including one or more of a source agent IP address, a test target agent IP address, a destination FQDN or a test target port.

11. The network device of claim 8, wherein the end-to-end network probe system comprises of one or more agents on one or more SD-WAN edge devices, wherein the path insight tool is configured to monitor the traffic flow from the one or more agents.

12. The network device of claim 8, wherein the path insight tool is configured to:
monitor the traffic flow having the flow identifier by the path insight tool; or
collect one or more sample data packets from the traffic flow when concurrent traffic flows exceeds a predetermined scale limit.

13. The network device of claim 8, wherein the computer-readable instructions further cause the one or more processors to:
constructing the test information received from the end-to-end network probe system in a mapping table comprising the one or more flow identifiers of tests associated with the test information.

14. The network device of claim 8, wherein generating the end-to-end visualization comprises:
identifying one or more internet protocol addresses associated with a test flow of an SD-WAN session between a source edge device and a destination edge device, the one or more internet protocol addresses including one or more hop addresses along a network path of the test flow of end-to-end network probe system;
identify from the one or more hop addresses a first hop address associated with the source edge device;
in response to identifying a match of the first hop address, identify from the one or more hop addresses a next hop address;
upon determining that the next hop address is a last hop, verifying that the last hop includes an IP address matching the destination edge device; and
merging the one or more hop addresses into the network path of the test flow of the SD-WAN session, wherein the network path is merged and utilized to generate the end-to-end visualization.

15. A non-transitory computer-readable storage medium comprising computer-readable instructions, which when executed by one or more processors of a network appliance, cause the network appliance to:
querying, by a path insight tool, an end-to-end network probe system to obtain test information about a traffic flow originating from an endpoint outside a software-defined wide area network (SD-WAN) by the end-to-end network probe system, the test information including one or more flow identifiers;
identifying from querying the end-to-end network probe system one or more SD-WAN overlay devices that carried the traffic flow having the one or more flow identifiers, wherein the one or more SD-WAN overlay devices are translated into an SD-WAN underlay path through the SD-WAN and statistics associated with the traffic flow obtained as the traffic flow traversed the SD-WAN underlay path;
identify a flow identifier that identifies the traffic flow in the end-to-end network probe system;
in response to identifying the flow identifier, associating the test information about the traffic flow from the end-to-end network probe system with the statistics associated with the traffic flow obtained as the traffic flow traversed the SD-WAN underlay path; and
generating an end-to-end visualization from the test information from the end-to-end network probe system and the statistics associated with the traffic flow as it traversed the SD-WAN underlay path.

16. The non-transitory computer-readable storage medium of claim 15, wherein the one or more processors are further configured to:
determining that the test information comprises a target uniform resource locator (URL); and
generating an end-to-end network probe system flow key from the one or more flow identifiers including a source agent IP address and a test target FQDN.

17. The non-transitory computer-readable storage medium of claim 15, wherein the one or more processors are further configured to:
determining that the test information does not include a target uniform resource locator (URL); and
generating an end-to-end network probe system flow key from the one or more flow identifiers including one or more of a source agent IP address, a test target agent IP address, a destination FQDN or a test target port.

18. The non-transitory computer-readable storage medium of claim 15, wherein the path insight tool is configured to:
monitor the traffic flow having the flow identifier by the path insight tool; or
collect one or more sample data packets from the traffic flow when concurrent traffic flows exceeds a predetermined scale limit.

19. The non-transitory computer-readable storage medium of claim 15, wherein the one or more processors are further configured to:
constructing the test information received from the end-to-end network probe system in a mapping table comprising the one or more flow identifiers of tests associated with the test information.

20. The non-transitory computer-readable storage medium of claim 15, wherein generating the end-to-end visualization comprises:
identifying one or more internet protocol addresses associated with a test flow of an SD-WAN session between a source edge device and a destination edge device, the one or more internet protocol addresses including one or more hop addresses along a network path of the test flow of the end-to-end network probe system;
identify from the one or more hop addresses a first hop address associated with the source edge device;
in response to identifying a match of the first hop address, identify from the one or more hop addresses a next hop address;
upon determining that the next hop address is a last hop, verifying that the last hop includes an IP address matching the destination edge device; and
merging the one or more hop addresses into the network path of the test flow of the SD-WAN session, wherein the network path is merged and utilized to generate the end-to-end visualization.
